(19) United States
(12) Patent Application Publication
(10) Pub. No.: US 2021/0197826 A1
(43) Pub. Date: Jul. 1, 2021

(54) METHOD FOR COORDINATING A VEHICLE GROUP, EVALUATION UNIT, VEHICLE AND VEHICLE GROUP

(71) Applicant: ZF CV Systems Hannover GmbH, Hannover (DE)

(72) Inventor: Mathias BAUM, Hannover (DE)

(21) Appl. No.: 17/199,455

(22) Filed: Mar. 12, 2021

Related U.S. Application Data
(63) Continuation of application No. PCT/EP2019/072419, filed on Aug. 22, 2019.

(30) Foreign Application Priority Data
Sep. 18, 2018 (DE) 10 2018 122 824.4

(51) Int. Cl. B60W 30/18; B60W 50/00; B60W 60/00; B60W 30/165; H04W 4/46; H04W 4/44

(52) U.S. Cl. CPC B60W 30/18163; B60W 50/00; B60W 60/00276; B60W 30/165; B60W 2050/008; H04W 4/44; B60W 2556/50; B60W 2556/65; H04W 4/46

(57) ABSTRACT

A method for coordinating a vehicle group having a number of vehicles, the vehicles of the vehicle group moving with specified setpoint distances to one another on a traffic lane and communicating wirelessly with one another via V2X communication, the specified setpoint distance being set by the respective vehicle by an adaptive cruise control system, includes: specifying the setpoint distances such that the vehicle group is permanently divided into a defined number of at least two partial vehicle groups and a guide partial vehicle group is followed by at least one following partial vehicle group, at least each following partial vehicle group being assigned its own guide vehicle, the guide vehicle of the respective following partial vehicle group leading the respective following partial vehicle group as the first vehicle; and specifying a setpoint distance for the guide vehicle of the respective following partial vehicle group.

### CROSS-REFERENCE TO PRIOR APPLICATIONS

This application is a continuation of International Patent Application No. PCT/EP2019/072419, filed on Aug. 22, 2019 which claims priority to German Patent Application No. DE 10 2018 122 824.4, filed on Sep. 18, 2018. The entire disclosure of both applications is incorporated by reference herein.

### FIELD

The invention relates to a method for coordinating a vehicle group composed of several vehicles, in particular utility vehicles, to an evaluation unit for carrying out the method, and to a vehicle, in particular lead vehicle, and to a vehicle group having such a vehicle or lead vehicle.

### BACKGROUND

It is known that several vehicles can move in an intercoordinated manner one behind the other on a traffic lane with short group following distances in order to save fuel owing to a reduced air resistance. Vehicles coordinated in this way are also referred to as a vehicle group, vehicle convoy or platoon. During such coordinated driving, the safety distance between the individual vehicles that is nowadays customary can be undershot if the vehicles coordinate with one another, for example via wireless V2X communication. The individual vehicles of the vehicle group are coordinated here for example by a lead vehicle, which can communicate with the other vehicles via the wireless V2X communication and exchange data, in particular driving dynamics characteristics of the respective vehicles. Furthermore, information regarding the surroundings, including the surrounding road users, can also be exchanged. The lead vehicle can in particular specify a setpoint distance which is then set by the individual vehicles of the vehicle group by means of an adaptive cruise control system. This can ensure that the individual vehicles in the vehicle group can react more quickly to one another, whereby an impairment of safety can be avoided and thus the undershooting of the safety distance can be justified, because the reaction times are shortened.

If such a vehicle group is traveling for example on a multi-lane road, for example a highway/motorway, the vehicle group, owing to the intercoordinated setting of the driving dynamics in order to maintain the specified setpoint distance, constitutes a very long obstruction for the vehicles that wish to pass across the traffic lane of the vehicle group. This obstruction, which extends in the direction of travel of the vehicle group of several vehicles, can be overcome in the transverse direction only with difficulty by a vehicle that is situated for example on the adjacent traffic lane. This may be necessary for example if the vehicle on the adjacent traffic lane wishes to move from the motorway onto an exit ramp and, for this purpose, has to change lanes across the traffic lane occupied by the vehicle group. The respective vehicle must therefore either brake heavily in order to be able to change lanes behind the last vehicle of the vehicle group, or accelerate so intensely that it can change lanes to the exit ramp in front of the first vehicle of the vehicle group. Such braking or acceleration of the vehicle in order to move to the end or the beginning of the vehicle group is however not possible in every traffic situation and also harbors certain dangers for the following traffic as well as for the respective vehicle itself.

The same disadvantage arises for a vehicle which is situated on an entry ramp of the motorway and which moves onto the traffic lane of the vehicle group at the point in time at which the vehicle group is also situated at this point. The entering vehicle also has an opportunity to enter the motorway only if it accelerates such that it reaches the traffic lane of the vehicle group in front of the first vehicle of the vehicle group or brakes such that it reaches this traffic lane behind the last vehicle of the vehicle group. Under certain circumstances, this can lead to the entering vehicle braking to a standstill, which has the disadvantageous consequence that it has to accelerate from a standstill in order to enter the motorway. Both possibilities for entering the motorway are therefore unsafe for the entering vehicle and also for the surrounding traffic.

To make allowance for this, it may be provided that the vehicle group is automatically broken up at entry ramps and exit ramps of the motorway in a manner controlled and/or coordinated by the lead vehicle of the vehicle group, for example the first vehicle of the vehicle group, such that the conventional safety distances between the vehicles are set again. Each vehicle then moves in an uncoordinated manner under the control of its respective driver. The driver can then, on the basis of their observations, brake their vehicle accordingly in order to enable the entering or exiting vehicle to change lanes. Furthermore, it may be provided that the driver of any vehicle of the vehicle group manually initiates a braking operation if they identify an entering or exiting vehicle. As a result, the vehicle group can be opened manually at any point in order to enable the entering or exiting vehicle to change lanes.

A disadvantage of these stated methods is that the vehicle group is at least temporarily not coordinated, and as a result the advantages of a vehicle group or platoon can no longer be ensured. In addition, following such a traffic situation that causes the vehicle group to break up, the vehicle group must again be correspondingly set up and coordinated with one another, which results in increased feedback control outlay.

Another solution provides that the number of vehicles in a vehicle group is limited, for example to three vehicles. The length of the obstruction is thus limited, such that, with an anticipatory driving style, entry or exit is readily possible.

Furthermore, it can be provided that, when an entry ramp or an exit ramp is identified, the vehicle group is temporarily divided into several partial vehicle groups (sub-platoons) in this region, regardless of whether a vehicle wishes to enter or exit. Here, a certain number of vehicles moves within each partial vehicle group, between which vehicles the group following distance is specified as the setpoint distance. An ingress distance is specified as the setpoint distance between the individual partial vehicle groups, which ingress distance allows entering and exiting vehicles to move onto the traffic lane of the vehicle group in the region of the entry ramp or the exit ramp. After the entry ramp or the exit ramp has been passed, the partial vehicle groups are automatically merged again. A disadvantage here is that individual vehicles of the vehicle group change their driving dynamics in the region of entry ramps and exit ramps even if no vehicle wishes to enter or exit. The partial vehicle groups then have to be merged again. Overall, unnecessary feedback control of the setpoint distances is thus carried out under certain circumstances, resulting in unnecessary braking and driving operations for some of the vehicles.

The automated setting of a setpoint distance following identification of a vehicle in the traffic lane of the vehicle group is known for example from DE 11 2014 004 023 T5. According to said document, coordinated driving still takes place if an unknown vehicle has already cut in between the vehicles of the vehicle group into its traffic lane. The vehicle group is accordingly subsequently divided into two partial vehicle groups owing to the unknown vehicle, wherein these continue to move in a coordinated manner with respect to one another. After the unknown vehicle has ingressed, an ingress distance can be set between the two partial vehicle groups, which ingress distance is greater than the conventional setpoint distance or group following distance between the individual vehicles. In this way, coordinated driving operation continues to be ensured, and it is at the same time ensured that the unknown vehicle does not obstruct the vehicles of the vehicle group or of the partial vehicle groups. A disadvantage here is that a reaction with an increase in distance is performed only when the unknown vehicle has already cut in. A division into several partial vehicle groups, and accordingly a reaction to the vehicle that has cut in, accordingly takes place only after the time at which the cutting-in occurs.

According to U.S. Pat. No. 9,396,661 B2, it is provided that a vehicle group can be divided into several vehicle groups if a vehicle moving in the vicinity requests, by means of a request signal, that said vehicle wishes to join the vehicle group. In a coordinated manner, an ingress distance is then set between two defined vehicles of the vehicle group, which ingress distance enables the vehicle which is ready to cut in to ingress into the vehicle group. Accordingly, in this case, too, the vehicle group is divided into two partial vehicle groups, wherein this occurs in response to an active request from the respective vehicle via wireless V2X communication. If a vehicle which is ready to cut in does not have such a means of communication, it can move onto the traffic lane of the vehicle group only in front of or behind the vehicle group, whereby entry into or exit from a motorway is made more difficult. A similar procedure is described in U.S. Pat. No. 9,799,224 B2.

In US 2016/0019782 A1, it is furthermore described that warning indications or warning information can be displayed to vehicles situated in the vicinity of the vehicle group, which warning indications or warning information cannot be perceived by the driver of the respective vehicle itself, for example owing to the extent of the vehicle group or of the individual vehicles.

### SUMMARY

In an embodiment, the present invention provides a method for coordinating a vehicle group comprising a number of vehicles, the vehicles of the vehicle group moving with specified setpoint distances to one another on a traffic lane and communicating wirelessly with one another via V2X communication, the specified setpoint distance being set by the respective vehicle by an adaptive cruise control system, comprising: specifying the setpoint distances such that the vehicle group is permanently divided into a defined number of at least two partial vehicle groups and a guide partial vehicle group is followed by at least one following partial vehicle group, at least each following partial vehicle group being assigned its own guide vehicle, the guide vehicle of the respective following partial vehicle group leading the respective following partial vehicle group as the first vehicle; and specifying a setpoint distance for the guide vehicle of the respective following partial vehicle group, which setpoint distance corresponds at least to a predefined ingress distance, wherein the ingress distance is defined such that, after setting the ingress distance as the setpoint distance to a directly preceding vehicle of the same vehicle group, an intermediate space forms between the respective partial vehicle groups such that a vehicle which is ready to cut in and which has a vehicle length not exceeding a predefined maximum length is movable onto the traffic lane of the vehicle group into the intermediate space between the at least two partial vehicle groups.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a vehicle group composed of several vehicles on a multi-lane road in an entry situation;

FIG. 2 shows a vehicle group composed of several vehicles on a multi-lane road in an exit situation;

FIG. 3 shows a flow diagram of the method according to the invention.

### DETAILED DESCRIPTION

In an embodiment, the present invention provides a method for coordinating vehicles of a vehicle group with which safe driving operation of the vehicles surrounding the vehicle group can be ensured. In an embodiment, the present invention provides an evaluation unit, a vehicle and a vehicle group.

According to the invention, it is therefore provided that, for coordinating a vehicle group composed of a number of vehicles, wherein the vehicles of the vehicle group move with specified setpoint distances to one another on a traffic lane and the vehicles communicate wirelessly with one another via V2X communication, wherein the specified setpoint distance is set by the respective vehicle by means of an adaptive cruise control system, the setpoint distances between these vehicles are specified such that the vehicle group is permanently divided into a defined number of at least two partial vehicle groups, such that a guide partial vehicle group is followed by at least one following partial vehicle group.

In order to achieve this, at least each following partial vehicle group is assigned its own guide vehicle, wherein the guide vehicle of the respective following partial vehicle group leads the respective following partial vehicle group as the first vehicle. Furthermore, a setpoint distance is specified for the guide vehicle of the respective following partial vehicle group, wherein said setpoint distance corresponds at least to a predefined ingress distance. In this way, an ingress distance which must be maintained between the partial vehicle groups in any case is advantageously defined already in advance. Accordingly, action is taken proactively and not only when a vehicle has already ingressed into the vehicle group, such that a vehicle which is ready to cut in can, from the outset, be given a safe opportunity to cross the traffic lane of the vehicle group.

According to the invention, the ingress distance is defined such that, after setting of the ingress distance as the setpoint distance to a directly preceding vehicle of the same vehicle group, an intermediate space forms between the respective partial vehicle groups such that a vehicle which is ready to cut in and which has a vehicle length not exceeding a predefined maximum length can move onto the traffic lane of the vehicle group into the intermediate space between the at least two partial vehicle groups.

Thus, from the outset, an intermediate space is defined into which a certain type of vehicles, namely those which do not exceed the maximum length, can cut in, without the vehicles of the vehicle group having to react with an adaptation of the driving dynamics. Furthermore, by contrast to the prior art, this intermediate space is set already before a vehicle cuts in and not only in response to this, such that the cutting-in process can also already be made safer. Because this intermediate space is set permanently, it is no longer necessary to change the driving dynamics of the vehicles, for example at the entry ramps and exit ramps of a highway/motorway, for vehicles that do not exceed the maximum length. In this way, more efficient driving operation can be ensured, and the closed-loop control outlay can be minimized. In addition, because the setpoint distance between the partial vehicle groups is not too great, there is an improved possibility of wireless communication between these than if the partial vehicle groups were independent of one another in terms of driving dynamics and were to thus, under certain circumstances, drive with very large setpoint distances to one another.

According to a preferred embodiment, it is provided that the ingress distance is defined in a manner dependent on the maximum length and a minimum distance in front of and behind the vehicle which is ready to cut in, wherein the maximum length is between 5 m and 10 m, preferably 6 m, and the minimum distance lies between 10 m and 25 m in each case in front of and behind the vehicle which is ready to cut in, such that the ingress distance is defined as being between 25 m and 60 m, preferably as being 35 meters.

Thus, the intermediate space is defined only in a manner dependent on geometrical dimensions of a vehicle that is potentially ready to cut in, in order to give this the opportunity to pass or cross the traffic lane of the vehicle group, that is to say if the vehicle group constitutes an obstruction owing to its length, for example at entry ramps or exit ramps. Furthermore, the application of a maximum length of 6 m encompasses a major proportion of the vehicles, in particular passenger motor vehicles, for which the vehicle group can constitute an obstruction, and which conventionally cannot communicate with the vehicle group and accordingly cannot make themselves known via wireless V2X communication. This already covers a major proportion of the driving situations in which it is necessary to divide the vehicle group in order to allow safe crossing of the traffic lane of the vehicle group through said vehicle group. However, the ingress distance should be smaller than the conventional safety distance such that the vehicle group is also perceived from the outside as a divided vehicle group and not as two independent vehicle groups and vehicles do not constantly cut in between the partial vehicle groups.

On the other hand, the application of the minimum distance takes into consideration a form of reduced safety distance. This ensures that the driver of the vehicle which is ready to cut in recognizes that they have been given an opportunity to drive through the obstruction with a high degree of safety. If the ingress distance is too short, the driver of a vehicle which is ready to cut in may otherwise react anxiously, as he considers ingressing into a very long vehicle group, composed for example of utility vehicles, to involve a high risk. In addition, the minimum distance can avoid the risk of rear-end collisions while the vehicle is situated between the partial vehicle groups. Specifically, unlike the vehicles of the vehicle group, the vehicle that has cut in does not coordinate with the other vehicles. However, the vehicle that has cut in does not normally remain in the intermediate space for very long. If it does, it may be provided that the ingress distance is correspondingly adapted and/or the vehicle that has cut in is given an indication that it should exit the traffic lane of the vehicle group.

According to a preferred refinement, it is provided that the setpoint distance which is specified for the guide vehicle of the respective following partial vehicle group is defined under the condition that, after setting of this setpoint distance, vehicles of different partial vehicle groups can continue to indirectly or directly communicate wirelessly with one another via the V2X communication for the purposes of coordinating the vehicle group as a whole. This advantageously achieves that the vehicle group as a whole can always be operated in a coordinated manner, in order to react to the present driving situation, despite the intermediate space formed. In this way, the second partial vehicle group (first following partial vehicle group) or also further following partial vehicle groups can still be given an instruction on how to react to a specific driving situation. At the same time, however, safe cutting-in into the traffic lane of the vehicle group is also allowed.

According to a preferred embodiment, it is furthermore provided that, for all other vehicles of the vehicle group that are not guide vehicles of a following partial vehicle group or the first vehicle of the vehicle group, a setpoint distance to a directly preceding vehicle of the same partial vehicle group is specified which corresponds to a group following distance, wherein the group following distance is smaller than the ingress distance. Accordingly, the rest of the vehicle group is operated in the usual way with setpoint distances that are smaller than the conventional safety distances, such that utilization of the slipstream is made possible with short reaction times owing to the V2X communication between the vehicles. For these group following distances, no provision is made for vehicles to cut in. Accordingly, according to a further embodiment, it is provided that the group following distance is defined and set—preferably exclusively—in a manner dependent on driving dynamics characteristics of the vehicles of the vehicle group, wherein the group following distance is less than 25 m, in particular less than 15 m. Geometrical or driving dynamics characteristics of vehicles that are not moving in the vehicle group are therefore not relevant for the definition of the group following distance.

Here, it is preferably provided that the driving dynamics characteristics of the vehicles of the vehicle group are transmitted via the V2X communication, such that the group following distances in the vehicle group can be easily defined in an intercoordinated manner.

According to a preferred refinement, it is provided that, in the context of the division of the vehicle group into at least two partial vehicle groups by specification and setting of the ingress distance as the setpoint distance in the guide vehicle of the respective following partial vehicle group, no communication is performed via the V2X communication with a vehicle which is ready to cut in. Accordingly, the division and the formation of the intermediate space takes place without an active request from the vehicle to the vehicle group. The vehicle group can therefore react only on the basis of the information defined by the vehicles of the vehicle group itself or observed or identified by the vehicle group itself.

It is preferably furthermore provided that, in the definition of the number of partial vehicle groups, it is taken into consideration that each partial vehicle group is composed of a maximum number of vehicles, wherein the maximum number is between three and eight and is particularly preferably five. It is thus advantageously achieved that a partial vehicle group does not become too long and accordingly the partial vehicle group also does not itself constitute a “partial obstruction” to which a vehicle which is ready to cut in can react only with great difficulty, that is to say by intense acceleration or braking.

According to a preferred refinement, it is provided that the setpoint distance which is specified for the guide vehicle of the respective following partial vehicle group and which corresponds at least to the ingress distance is defined additionally in a manner dependent on whether the intermediate space formed by the ingress distance between the respective vehicle groups allows cutting-in of a vehicle which has been identified as being ready to cut in and which has a vehicle length, wherein, if it is determined that cutting-in is not possible, the setpoint distance is increased proceeding from the ingress distance.

It is accordingly possible, for example in the context of a check of an ingress criterion, whether the predefined ingress distance is not sufficient to allow a vehicle to cut in. Specifically, if a particular maximum length is defined, it may be the case for certain vehicles, for example utility vehicles with trailers, etc., that the ingress distance is too small to allow safe cutting-in. If the maximum length were predefined for vehicles of this type also, then utilization of the slipstream can no longer be ensured. Likewise, it is not possible under all circumstances to identify, from the outside, that the vehicle group is divided. Rather, in the case of a large ingress distance, which allows even long utility vehicles with trailers to cut in, it will be assumed that there are two independent vehicle groups. Vehicles in the surroundings will then also constantly cut into the intermediate space thus formed, wherein the coordinated driving operation is disrupted.

Thus, for this exception where longer vehicles also wish to cut in, the setpoint distance can be increased proceeding from the ingress distance. Accordingly, it is considered that, in certain, less frequently occurring driving situations, it makes more sense from a safety aspect to at least briefly interrupt the efficient driving operation.

In order to achieve this, it can, for the definition of the setpoint distance, preferably be checked whether the vehicle length of the vehicle which has been identified as being ready to cut in exceeds the specified maximum length, wherein, in the event of an exceedance of the maximum length, the setpoint distance is increased by a distance amount proceeding from the ingress distance. Here, the increase takes place for example incrementally until the difference between the vehicle length and the maximum length has been compensated. Alternatively, the distance amount may be defined once in a manner dependent on the identified vehicle length, and the setpoint distance may be correspondingly adapted proceeding from the ingress distance. In this way, it is possible for space to be made in targeted fashion for a longer vehicle which is ready to cut in, and for the intermediate space to thus not be unduly increased in size. Here, too, the setpoint distance may be defined such that the V2X communication between the partial vehicle groups can continue to be maintained.

According to a preferred embodiment, it may furthermore be provided that the identification of whether a vehicle is ready to cut in and the ascertainment of the vehicle length of the vehicle which has been identified as being ready to cut in is performed in a manner dependent on surroundings data, wherein the surroundings data are output by at least one surroundings detection system, wherein the respective surroundings detection system monitors surroundings around the vehicle group. Thus, the adaptation or the increase of the setpoint distance is performed exclusively on the basis of surroundings data that describe the surroundings around the vehicle group, and not on the basis of request signals from other vehicles that wish to cut in. The vehicle group thus itself identifies whether the vehicle that is cutting in requires more space. For this purpose, it may for example be provided that trajectories of the moving vehicles are ascertained in an evaluation unit from the surroundings data, which trajectories predict the movement of the respective vehicle. If it follows from this that the respective vehicle intends to ingress into the intermediate space, it can be correspondingly checked, by way of the vehicle length, whether the vehicle fits into the intermediate space. If not, the setpoint distance can be correspondingly increased proceeding from the ingress distance. Furthermore, ingress indications may also be extracted from the surroundings data, for example the activation of a turn signal or of a headlamp flasher, which may likewise be an indication of whether the vehicle intends to ingress into the intermediate space and thus ingress into the traffic lane of the vehicle group between the vehicles of the vehicle group.

According to a preferred refinement, it is provided here that the surroundings data are transmitted via the V2X communication between the vehicles of the vehicle group and/or between the vehicles and an infrastructure facility outside the vehicle group, which infrastructure facility has an external surroundings detection system. Accordingly, with internal surroundings detection systems that are already present in the vehicles, and/or with recourse to surroundings detection systems in the surroundings, which for example monitor an entry ramp and/or an exit ramp, it can be identified whether an adaptation of the setpoint distance is necessary. These data can be provided in a simple manner via the V2X communication, wherein the processing of this data can then preferably take place in an evaluation unit in one of the vehicles of the vehicle group, which then defines the setpoint distance for the guide vehicle of the respective partial vehicle group.

In order to make the check more reliable, it may preferably be provided that the surroundings data from different surroundings detection systems are merged. In this way, improved depth information can be extracted or the detection region can be enlarged, because a surroundings detection system in one of the rear vehicles or outside the vehicle group in an infrastructure facility may see more or different regions of the surroundings than the surroundings detection system in the front vehicles of the vehicle group. Furthermore, it can be achieved in this way that the vehicles require fewer sensors in order to adequately detect the surroundings (in particular laterally), because the rear vehicles can also cover lateral regions of the vehicle in front using conventionally forward-facing sensors.

According to a further embodiment, it is provided that checking of whether the intermediate space formed by the ingress distance between the respective partial vehicle groups allows cutting-in of a vehicle which has been identified as being ready to cut in and which has the vehicle length is performed only if the vehicle group is approaching an entry ramp and/or an exit ramp, such that an increase of the setpoint distance proceeding from the ingress distance can be performed only if the vehicle group is approaching an entry ramp and/or an exit ramp. In this way, it can advantageously be avoided that the setpoint distance is constantly adapted owing to overtaking vehicles. An adaptation should accordingly take place only if it is highly likely that the vehicle group constitutes an obstruction.

According to a preferred refinement, it is provided that, after a detection that the vehicle which is ready to cut in has moved away again from the intermediate space, the ingress distance is specified as the setpoint distance for the guide vehicle of the respective following partial vehicle group. Accordingly, the partial vehicle groups are then brought together again so as to advantageously not offer any space for vehicles cutting in unnecessarily, and so as to be able to better utilize the slipstream again. In addition, the V2X communication between the partial vehicle groups improves with a smaller setpoint distance, especially in comparison with vehicle groups which drive independently of one another and which can thus have significantly larger distances to one another.

According to a preferred refinement, it is furthermore provided that the setpoint distance which is specified for the guide vehicle of the respective following partial vehicle group and which corresponds at least to the ingress distance is defined additionally in a manner dependent on whether two or more vehicles which are ready to cut in are identified. Advantageously, it is thus also possible for more than one vehicle to be given space to cross if this is considered efficient and sensible, for example if two vehicles wish to enter directly one behind the other and the vehicle group thus does not have to be opened to too great an extent.

According to a further embodiment, it is provided that the vehicle which is ready to cut in is an entering vehicle, which intends to move from an entry ramp onto the traffic lane of the vehicle group, or is a vehicle which is ready to exit, which intends to move from an adjacent traffic lane via the traffic lane of the vehicle group onto an exit ramp. Other cutting-in processes are however basically also possible.

According to the invention, an evaluation unit is also provided, by means of which the described method can be carried out, wherein the evaluation unit is designed to define the setpoint distances between vehicles of a vehicle group such that the vehicle group is permanently divided into a defined number of at least two partial vehicle groups, such that a guide partial vehicle group is followed by at least one following partial vehicle group, wherein, for this purpose, the evaluation unit

can assign at least each following partial vehicle group a guide vehicle, wherein the guide vehicle of the respective following partial vehicle group leads the respective following partial vehicle group as the first vehicle; and

can specify a setpoint distance for the guide vehicle of the respective following partial vehicle group, which setpoint distance corresponds at least to a predefined ingress distance,

wherein the ingress distance is defined such that, after setting of the ingress distance as the setpoint distance to a directly preceding vehicle of the same vehicle group, an intermediate space forms between the respective partial vehicle groups such that a vehicle which is ready to cut in and which has a vehicle length not exceeding a predefined maximum length can move onto the traffic lane of the vehicle group into the intermediate space between the at least two partial vehicle groups.

According to the invention, a vehicle which functions in particular as a lead vehicle in a vehicle group is provided, which has an evaluation unit of said type. Furthermore, a vehicle group composed of several vehicles is provided, wherein at least one of the vehicles, as lead vehicle, has an evaluation unit of said type, and the lead vehicle can communicate wirelessly with the vehicles of the vehicle group via V2X communication, wherein the vehicles each have an adaptive cruise control system, wherein the adaptive cruise control system is in each case designed to set the setpoint distance, which is specified by the lead vehicle by means of the evaluation unit and which is transmitted via the V2X communication, to the respectively preceding vehicle of the vehicle group for the purposes of permanently dividing the vehicle group into at least two partial vehicle groups.

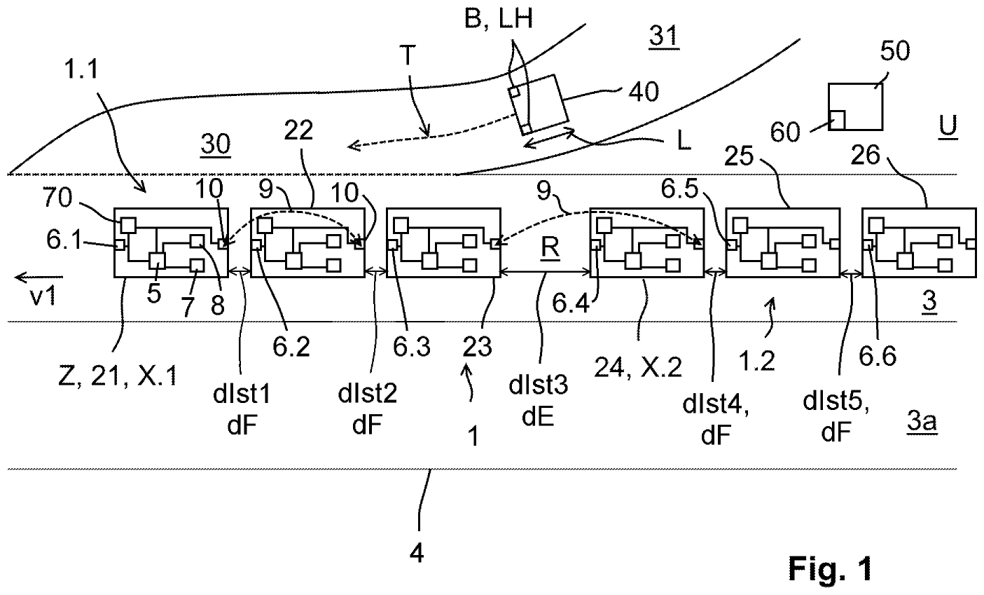

According to FIG. 1, a vehicle group 1 composed of a number N of six vehicles 2i, where i=1, 2, . . . N, is illustrated, which are moving with a particular actual distance dlstj, where j=1, 2, . . . N-1, to one another on a traffic lane 3 of a multi-lane road 4, for example of a highway. Here, in the context of the invention, a vehicle group 1 is to be understood to mean a series of vehicles 2i that are moving in an intercoordinated manner in order to ensure the most economical driving operation possible through utilization of the slipstream and avoidance of unnecessary acceleration and deceleration phases. Such a vehicle group 1 is also known to the person skilled in the art as a vehicle column or platoon.

The vehicle group 1 according to FIG. 1 is divided into a number M of two partial vehicle groups 1.1, 1.2 during its normal movement on the traffic lane 3, wherein a guide partial vehicle group 1.1 is followed by a following partial vehicle group 1.2, wherein each partial vehicle group 1.1, 1.2 each is composed of in each case three vehicles 2i. If further vehicles 2i, that is to say N>6, are provided in the vehicle group 1, it is also possible for more than two partial vehicle groups 1.k, where k=1, 2, 3, . . . , M, that is to say more than one following partial vehicle group 1.k, k>1, and/or partial vehicle groups 1.k with in each case more than three vehicles 2i, but preferably not more than in each case eight vehicles 2.i, to be formed.

The first vehicle 21, 24 of the respective partial vehicle group 1.k will hereinafter be referred to as guide vehicle X.k of the k-th partial vehicle group 1.k, which thus leads the respective partial vehicle group 1.k. Accordingly, in FIG. 1, the first vehicle 21 of the vehicle group 1 is simultaneously also the guide vehicle X.1 of the first partial vehicle group 1.1 or of the guide partial vehicle group 1.1, and the fourth vehicle 24 of the vehicle group 1 is the guide vehicle X.2 of the second partial vehicle group 1.2 or of the first following partial vehicle group 1.2.

The distance between the partial vehicle groups 1.k, in FIG. 1 the third actual distance dIst3 between the third vehicle 23 or the last vehicle of the first partial vehicle group 1.1 (guide partial vehicle group 1.1) and the fourth vehicle 24 or the guide vehicle X.2 of the second partial vehicle group 1.2 (first following partial vehicle group 1.2), will hereinafter generally be referred to as ingress distance dE, which thus indicates a length of an intermediate space R between the partial vehicle groups 1.k. Here, the ingress distance dE is larger than the actual distance dIstj that is normally set between vehicles 2i of the same partial vehicle group 1.1, 1.2.

The vehicle group 1 as a whole, composed of the two (or more) partial vehicle groups 1.k, is coordinated by a lead vehicle Z, which in FIG. 1 is simultaneously the first vehicle 21 of the vehicle group 1. In principle, however, it is also possible for one of the other vehicles 2i to be the lead vehicle Z. To coordinate the vehicle group 1, the lead vehicle Z defines, on the basis of predetermined parameters, the setpoint distance dSollj, where j =1, 2, . . . N-1, with which the individual vehicles 2i of the vehicle group 1 should move relative to one another.

The setpoint distance dSollj between the individual vehicles 2i may be defined in different ways:

On the one hand, the definition may be performed for example in a manner dependent on vehicle-specific characteristics of the respective vehicle 2i, for example a braking capability, a vehicle status, etc., as well as with the stipulation that particularly efficient driving operation is made possible in the vehicle group 1 as a whole, utilizing the slipstream. A so-called group following distance dF defined in this way as setpoint distance dSollj between the respective vehicles 2i may be smaller than the conventional safety distance between two vehicles, because the vehicles 2i move in an intercoordinated manner and communicate with one another, whereby safe driving operation can even then still be ensured.

On the other hand, the setpoint distance dSollj may also be defined in a manner dependent on which vehicle 2i of the vehicle group 1 is to be the guide vehicle X.k of a partial vehicle group 1.k, in particular following partial vehicle group 1.k, k>1. The first guide vehicle X.1 of the guide partial vehicle group 1.1 is excluded from this, since it cannot set a setpoint distance dSollj to a preceding vehicle 2i of the same vehicle group 1. However, it may be provided that the adaptive cruise control system 5 of the guide vehicle X.1 of the guide partial vehicle group 1.1 is used to set a conventional safety distance to a preceding vehicle in the surroundings U which is not part of the vehicle group 1. The lead vehicle Z thus defines where the vehicle group 1 is to be divided. For this purpose, the ingress distance dE is defined for the setpoint distance dSollj of the respective vehicle 2i, which ingress distance is then conventionally larger than the defined group following distance dF for the vehicles 2i within a partial vehicle group 1.k.

In order to be able to set the respectively defined setpoint distance dSollj between the individual vehicles 2i, each of the vehicles 2i has an adaptive cruise control system 5, wherein, by means thereof, in the manner of an intelligent cruise control system, the in each case i-th vehicle 2i detects the actual distance dIstj (where j=i−1) to the respectively preceding (i−1)-th vehicle 2(i−1) by means of an internal surroundings detection system 6i in the subject vehicle 2i, and, through an intervention in the brake system 7 and/or the drive system 8 of the subject vehicle 2i, adjusts the detected actual distance dIstj to the setpoint distance dSollj (where j=i−1), specified by the lead vehicle Z, to the preceding (i−1)-th vehicle 2(i−1).

The transmission of the defined setpoint distance dSollj from the lead vehicle Z to the respective vehicles 2i of the vehicle group 1 takes place via wireless V2X communication 9, which is established between the individual vehicles 2i. For this purpose, in each of the vehicles 2i, there is arranged a V2X unit 10 which, in a conventional manner, has a transmitting and receiving module by means of which, in particular, the setpoint distance dSollj can be transmitted and received, such that this can be set by means of the adaptive cruise control system 5 in the respective vehicle 2i. For this purpose, the adaptive cruise control system 5 is connected to the V2X unit 10 in any signal-conducting manner.

V2X (Vehicle-to-Everything) is a wireless communication facility that allows the individual vehicles 2i to provide signals via a specific interface or in accordance with a specific protocol in order to coordinate with one another. If such communication takes place only between the vehicles 2i, it is referred to as V2V (Vehicle-to-Vehicle). However, communication between a vehicle 2i and an infrastructure facility 50 at the edge of the traffic lane 3 is also possible, which is then referred to as V2I (Vehicle-to-Infrastructure).

For example, a short-range DSRC connection (Dedicated Short-Range Communication) or a wireless connection according to one of the IEEE standards, for example IEEE 802.11 (Wireless Access in Vehicular Environments (WAVE)) or IEEE 802.11p (see IEEE 802.11 Wireless LAN medium access layer (MAC)), may be used as the form of transmission. The V2X unit 10 may for example allow signal transmission via WiFi, WLAN, Ultra Mobile Broadband (UMB), Bluetooth (BT), Near Field Communication (NFC), Radio Frequency Identification (RFID), Z-wave, ZigBee, Low power Wireless Personal Area Networks (6LoWPAN), Wireless Highway Addressable Remote Transducer (HART) Protocol, Wireless Universal Serial Bus (USB) or via optical communication facilities, for example Infrared Data Association (IrDA). Alternatively, transmissions are however also possible by means of the (mobile radio) standards 3GPP LTE, LTE-Advanced, E-UTRAN, UMTS, GSM, GSM/EDGE, WCDMA, Time Division Multiple Access (TDMA), Frequency Division Multiple Access (FDMA), Orthogonal FDMA (OFDMA), Single-Carrier FDMA (SC-FDMA), Worldwide Interoperability for Microwave Access (WiMax), Ultra Mobile Broadband (UMB), High Speed Packet Access (HSPA), Evolved Universal Terrestrial Radio Access (E-UTRA), Universal Terrestrial Radio Access (UTRA), GSM EDGE Radio Access Network (GERAN), etc.

The thus set-up vehicle group 1 composed of the two partial vehicle groups 1.k moves, after setting of the respective setpoint distances dSollj, at a certain group speed v1 on the traffic lane 3, wherein each partial vehicle group 1.k moves at the group speed v1 in the normal state. If such a vehicle group 1 moves toward an entry ramp region 30 of the multi-lane road 4, via which an entering vehicle 40 can move from an entry ramp 31 onto the multi-lane road 4, the vehicle group 1 may constitute an obstruction for this entering vehicle 40. This is the case specifically when the entering vehicle 40 in the entry ramp region 30 is ready to enter the traffic lane 3 while the vehicle group 1 is presently passing the entry ramp region 30.

In order to counteract this, the entering vehicle 40 can, in an anticipatory manner, drive along the entry ramp 31 such that it moves onto the traffic lane 3 in front of or behind the vehicle group 1. In the case of a very long vehicle group 1, however, this may constitute a safety risk, because the entering vehicle 40 has to accelerate too intensely or drive on the hard shoulder in order to cut in in front of the vehicle group 1, or has to brake heavily, and under certain circumstances almost to a standstill, in order to cut in behind the vehicle group 1.

Another possibility is to cut in between the vehicles 2i of the vehicle group 1. The group following distance dF between the vehicles 2i of a partial vehicle group 1.k is however normally so small, for example 10 m, that, in the case of a high group speed v1 of approximately 70-90 km/h, it is very difficult for an entering vehicle 40 to cut in without taking increased safety risks.

The inventive division of the vehicle group 1 however makes it easier for the entering vehicle 40 to drive onto the multi-lane road 3 into the intermediate space R between the multiple partial vehicle groups 1.k, because the ingress distance dE is larger than the group following distance dF. The ingress distance dE may for example be between 45 m and 70 m. Thus, depending on the number M of partial vehicle groups 1.k, the entering vehicle 40 is given at least one further opportunity to cut in which is less safety-critical than cutting in between the vehicles 2i of a partial vehicle group 1.k or in front of and behind the vehicle group 1 as a whole.

To ingress between the vehicle groups 1.k, only a slight anticipatory speed adaptation by the entering vehicle 40 is necessary. In the simplest case, the vehicle group 1 does not have to react, such that the coordinated driving is not disrupted and braking or acceleration operations can be avoided entirely. This makes it possible to avoid an increased safety risk both for the entering vehicle 40 and for the vehicle group 1 and also for other road users.

Here, the ingress distance dE is set such that entering vehicles 40, preferably passenger motor vehicles, with vehicle lengths L of conventionally up to 6 meters, can cut in and are not placed in danger in the process. A maximum length LMax is therefore applied for the entering vehicle 40. In addition, a minimum distance dmin is taken into consideration, which must be maintained in any case between the entering vehicle 40 of vehicle length L and the partial vehicle group 1.k travelling in front of and behind said entering vehicle. The ingress distance dE may accordingly be defined for example as being a value between 25 m and 60 m, in particular as being 35 m. Here, it must be taken into consideration that entering vehicles 40 normally remain on the traffic lane 3 of the vehicle group 1 between the partial vehicle groups 1.k only briefly, and will change lanes a short time later in order to overtake the vehicle group 1 or fall behind the vehicle group 1.

Furthermore, in the definition of the ingress distance dE as the setpoint distance dSollj, it is taken into consideration that the vehicles 2i of the vehicle group 1 as a whole can continue to communicate via the wireless V2X communication 9. The partial vehicle groups 1.k are accordingly not separated from one another to too great an extent, in order to continue to ensure intercoordinated and efficient driving operation over the vehicle group 1 as a whole. At the same time, however, it is made possible for an entering vehicle 40 to safely and reliably cut in without disrupting the driving operation of the vehicle group 1.

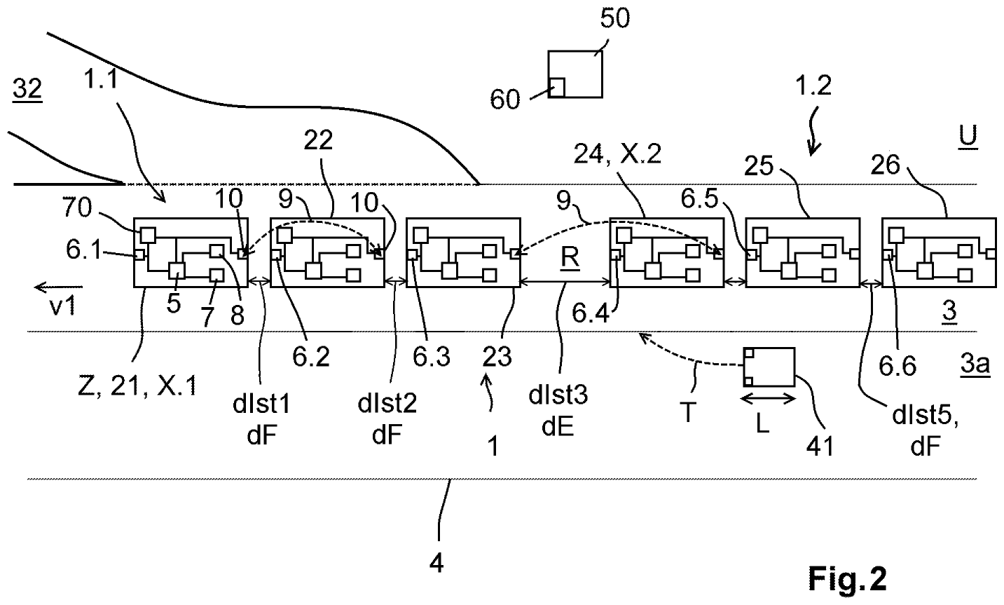

FIG. 2 illustrates an exit situation, on the basis of which a further embodiment of the invention will be described below. The procedure here is similar to that in the entry situation illustrated in FIG. 1.

Accordingly, it is provided that a vehicle 41 which is ready to exit is situated on the adjacent traffic lane 3a in relation to the vehicle group 1. Said vehicle intends to take the next exit ramp 32 from the multi-lane road 4, wherein, in this case, too, the vehicle group 1 may again constitute an obstruction. The vehicle 41 which is ready to exit may accordingly attempt, by accelerating or decelerating, to move onto the traffic lane 3 of the vehicle group 1 in front of or behind the vehicle group 1 in order to subsequently move onto the exit ramp 32, though this is not always possible without impeding the other traffic.

Furthermore, said vehicle may also cut in onto the traffic lane 3 between the vehicles 2i of the vehicle group 1. Here, too, the division into two partial vehicle groups 1.k can create an additional safe opportunity for a lane change in the direction of the exit ramp 32, because the vehicle 41 which is ready to exit can, by way of a corresponding anticipatory speed adaptation, cut into the intermediate space R with the ingress distance dE which is provided for such lane changes.

Furthermore, the intermediate space R between the partial vehicle groups 1.k may also be available for other, short-term cutting-in maneuvers in which another vehicle intends to change lanes “through” the vehicle group 1. For all of the stated cutting-in maneuvers, it is the case here that the respective vehicle 40, 41 which is ready to cut in does not communicate with the vehicle group 1 in order to coordinate the lane change therewith. Thus, no request on the basis of which the vehicles 2i of the vehicle group 1 can or could react is issued by the respective vehicle 40, 41 which is ready to cut in.

According to an adapted embodiment, it may be provided for the stated lane change processes “through” the vehicle group 1 that the setpoint distance dSollj between the partial vehicle groups 1.k is adapted if certain ingress criteria K are present, preferably is increased proceeding from the ingress distance dE, wherein this is coordinated from the lead vehicle Z. Accordingly, under given circumstances, the vehicle group 1 still reacts to certain events in the surroundings U when it no longer appears sensible to set the ingress distance dE. In this case, however, the events are not triggered by active communication between the cutting-in vehicle 40, 41 and the vehicles 2i of the vehicle group 1. Rather, the vehicle group 1 itself identifies such an event.

The ingress criterion K may be met for example if it is determined that an entering vehicle 40 or a vehicle 41 which is ready to exit or the vehicle which is cutting in for other reasons is too long, that is to say exceeds the maximum length LMax, and therefore cannot, from a safety aspect, cut into the intermediate space R with the ingress distance dE. Here, it may in particular be taken into consideration that cutting-in in front of or behind the vehicle group 1 also does not appear possible or sensible. For example, if it is determined that a vehicle 40, 41 of vehicle length L that may cut in does not “fit” into the intermediate space R in the case of the presently set setpoint distance dSollj or the ingress distance dE, taking into consideration the minimum distance dmin (to the front and to the rear), that is to say L+2×dmin>dE=dSollj, then the ingress criterion K can be regarded as fulfilled. The setpoint distance dSollj is thereupon increased by a certain distance amount dB, for example incrementally, proceeding from the ingress distance dE until the following applies again: dSollj=dE+dB≥L+2×dmin. Thus, the difference between the vehicle length L and the maximum length LMax is compensated for by the distance amount dB.

The checking of the ingress criterion K is performed in the lead vehicle Z on the basis of surroundings data UD, which are provided via the wireless V2X communication 9. Here, the surroundings data UD may be provided from the vehicles 2i of the vehicle group 1 itself or from an external source, for example from an infrastructure facility 50. Here, the surroundings data UD include information recorded from the surroundings U, from which it can be derived

1.) whether, in the surroundings U around the vehicle group 1, there is a vehicle 40, 41 that is likely to intend to move onto the traffic lane 3 of the vehicle group 1, and

2.) whether this detected vehicle 40, 41 with the vehicle length L can safely and reliably cut into the intermediate space R between the partial vehicle groups 1.k in the case of the defined ingress distance dE, taking into consideration the minimum distance dmin, that is to say whether the vehicle length L of said vehicle is greater or less than the applied maximum length LMax.

This information can be extracted for example from the surroundings data UD, which is recorded and output by the internal surroundings detection system 6i in the respective vehicle 2i of the vehicle group 1 or else by an external surroundings detection system 60 outside of the vehicles 2i, for example at the respective infrastructure facility 50. For this purpose, the respective surroundings detection system 6i, 60 has for example a camera and/or a radar system and/or LIDAR, which can in each case detect objects in the surroundings U and output the surroundings data UD in each case in a manner dependent thereon. Conventional vehicles 2i are advantageously already equipped with an internal surroundings detection system 6i, for example in the context of the adaptive cruise control system 5, such that no retrofitting is required and it is necessary only to provide an output via the V2X communication 9 by means of the V2X unit 10, such that the lead vehicle Z can access said output.

Advantageously, the lead vehicle Z can thus not only evaluate the present surroundings situation in a manner dependent on the perspective of its own surroundings detection system 61, but can also detect and evaluate the current surroundings situation from a different perspective, that is to say for example from the perspective of the rear vehicles 2i, where i>1, or else of the infrastructure facility 50 outside the traffic lane 3. A merging of surroundings data UD from different surroundings detection systems 6i, 60 may also be performed in order to increase the reliability of the check of the ingress criterion K. For example, a vehicle 2i of the vehicle group 1 which is traveling further toward the rear can provide more precise depth information regarding the surroundings U or identified vehicles 40, 41, and thus allow a more precise determination of the future traveling movement of the vehicle 40, 41, for example in the form of a predicted trajectory T, as well as of the vehicle length L. In addition, a vehicle 2i of the vehicle group 1 which is situated further toward the rear can detect surroundings data UD which cannot be detected by the lead vehicle Z, for example because the detection range of the surroundings detection system 61 in the lead vehicle Z does not allow this.

Here, the evaluation and assessment of the surroundings data UD is performed in an evaluation unit 70 in the lead vehicle Z, in which the ingress criterion K is checked for each identified, preferably moving object in the surroundings U. Here, the assessment of a moving object is performed for example by means of an object detection algorithm which identifies object contours from the output surroundings data UD and tracks these, preferably with depth resolution, over the course of time. From this, it is possible to predict a trajectory T for the respective identified object or vehicle 40, 41 and, from this, whether the vehicle 40, 41 intends to cut into the traffic lane 3 of the vehicle group 1 at all, and whether or not this cutting-in maneuver is likely to take place in the region of the intermediate space R between the partial vehicle groups 1.k.

If a cutting-in maneuver in the intermediate space R is likely, then it is checked in the next step whether a vehicle length L of the vehicle 40, 41 which is ready to cut in fits the set ingress distance dE, that is to say whether L+2×dmin>dE=dSollj or L<LMax. If this is not the case, then the ingress criterion K is fulfilled. The lead vehicle Z thereupon, via the V2X communication 9, transmits a setpoint distance dSollj to the guide vehicle X.k, k>1 of the respective following partial vehicle group 1.k, k>1, for which dSollj=dE+dB≥L+2×dmin. This setpoint distance dSollj is then set by means of the adaptive cruise control system 5 of the guide vehicle X.k, k>1 of the respective following partial vehicle group 1.k, k>1 by virtue of said adaptive cruise control system performing a braking operation by means of the brake system 7. All other vehicles 2i of this following partial vehicle group 1.k, k>1 then follow the changed movement of the guide vehicle X.k, k>1 of the respective following partial vehicle group 1.k, k>1, such that the movement of the vehicle group 1 as a whole remains intercoordinated.

In addition or as an alternative to the ascertainment of the trajectory T of the respective vehicle 40, 41 in order to determine whether the vehicle 40, 41 is likely to wish to cut in, it may be checked on the basis of the available surroundings data UD whether the vehicle 40, 41 is in any way indicating, by way of a cut-in indication H, that it wishes to move onto the traffic lane 3 of the vehicle group 1. For this purpose, it is for example possible to check the activation of a turn signal B of the respective vehicle 40, 41 in the direction of the traffic lane 3 of the vehicle group 1 as a cut-in indication H. From the surroundings data UD, it is also possible to extract, as a cut-in indication H, whether the respective vehicle 40, 41 has activated a headlamp flasher LH.

Furthermore, in the context of the check as to whether the ingress criterion K is fulfilled, the presence of an entry ramp 31 or of the exit ramp 32 may also be decisive. It may thus be defined that a lane change for a long vehicle 40, 41 is actually made possible only if the vehicle group 1 is highly likely to constitute an obstruction for lane-changing vehicles 40, 41. This can prevent the vehicle 40, 41 from sitting permanently between the partial vehicle groups 1.k.

Only when the vehicle 40, 41 has left the traffic lane 3 of the vehicle group 1 again, which is likewise detected by means of the surroundings detection systems 6i, 60, are the two partial vehicle groups 1.k brought together again in a manner coordinated by the lead vehicle Z, by virtue of the ingress distance dE again being specified as the setpoint distance dSollj for the guide vehicle X.k, k>1 of the respective following partial vehicle group 1.k, k>1 and the vehicle group 1 continuing its journey as before. For this purpose, the guide vehicle X.k, k>1 of the respective following partial vehicle group 1.k, k>1 and all other vehicles 2i that follow behind are accelerated again in an intercoordinated manner by means of the adaptive cruise control systems 5 in order to continue the coordinated journey.

In principle, with the method described, it is also possible for the setpoint distance dSollj to be increased, proceeding from the ingress distance dE, by a distance amount dB which allows more than one vehicle 40, 41 to cut into the intermediate space R. This may be useful for example if two vehicles 40 entering directly one behind the other are in the driving situation according to FIG. 1 or two vehicles 41 which are ready to exit are in the driving situation according to FIG. 2, for each of which vehicles the ingress criterion K is met. However, it is necessary to consider the number of vehicles 40, 41 which are ready to cut in for which it makes sense to form an intermediate space R without thus impeding the other traffic and/or losing the capability of coordinating the vehicle group 1.

If, in all of the abovementioned embodiments, one or more vehicles 40, 41 which are ready to cut in remain in the intermediate space R for a relatively long period of time, provision may be made for the setpoint distance dSollj to be increased further. In this way, permanently safe driving operation can be ensured even if a vehicle 40, 41 driving in the vehicle group 1 does not communicate with the latter via the V2X communication 9.

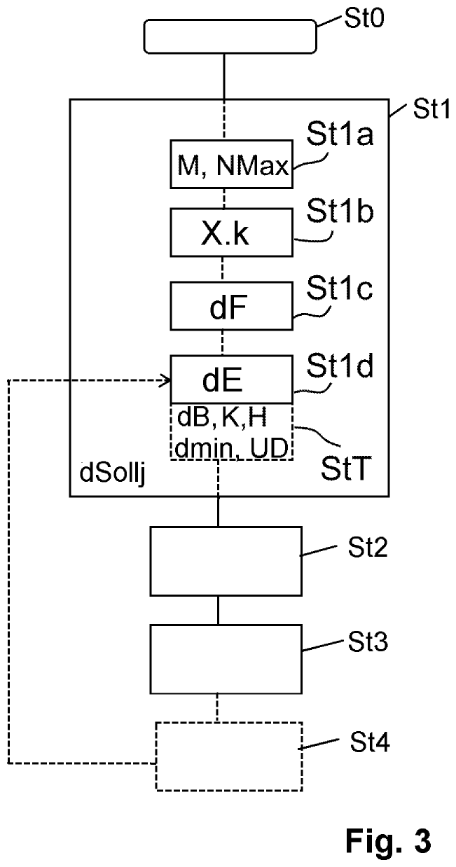

According to FIG. 3, the method according to the invention can be carried out for example as follows:

An initialization takes place in an initial step St0, for example with the set-up of the vehicle group 1. In a subsequent first step St1, the setpoint distances dSollj between the individual vehicles 2i of the vehicle group 1 are defined in a coordinated manner. Here, the vehicle group 1 is divided into a number M of at least two partial vehicle groups 1.k in a manner dependent on the number N of vehicles 2i (St1a). Here, the number M may be based in particular on the maximum number NMax of vehicles 2.i within a partial vehicle group 1.k. For this purpose, at least for each following partial vehicle group 1.k, k>1 guide vehicles X.k, k>1 are defined (St1b). For the vehicles 2i within a partial vehicle group 1.k, group following distances dF are subsequently specified as setpoint distances dSollj (St1c) and, for the guide vehicle X.k, k>1 of the respective following partial vehicle group 1.k, k>1, an ingress distance dE which is greater than the group following distance dF is specified (St1d). The ingress distance dE allows vehicles 40, 41 of conventional vehicle lengths L of up to 6 meters to cut in, taking into consideration a minimum distance dmin to the front and to the rear. The defined setpoint distances dSollj are subsequently, in a second step St2, transmitted to the respective vehicles 2i in the vehicle group via the V2X communication 9, and, in a third step St3, are implemented in the respective vehicle 2i by means of the adaptive cruise control system 5.

According to one embodiment, it may be provided that, in step St1d, the setpoint distance dSollj is set to the ingress distance dE plus a distance amount dB, that is to say the intermediate space R between the partial vehicle groups 1.k is increased if for example it is determined that a vehicle 40, 41 which is ready to cut in does not fit into the intermediate space R, taking into consideration the minimum distance dmin.

This is performed in a substep StT by evaluation of the surroundings data UD and the check of the ingress criteria K and of the cut-in indications H, as described above. After the vehicle 40, 41 has left the intermediate space R again, the partial vehicle groups 1.k can be brought together in a fourth step St4, wherein, for this purpose, the setpoint distance dSollj of the guide vehicle X.k of the respective following partial vehicle group 1.k, k>1 is defined again as being the original ingress distance dE. The check in step St1d and the subsequent bringing-together in the fourth step St4 may be performed continuously, for example in order to be able to react correspondingly at every entry ramp 31 or exit ramp 32.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS (PART OF THE DESCRIPTION)

1 Vehicle group

1.k k-th partial vehicle group

1.1 Guide partial vehicle group

1.k, k>1 Following partial vehicle group

2i i-th vehicle in vehicle group 1

Traffic lane of the vehicle group 1

3a Adjacent traffic lane

4 Multi-lane road

5 Adaptive cruise control system

6i Internal surroundings detection system in the i-th vehicle 2i

7 Brake system

8 Drive system

9 Wireless communication

10 V2X unit

30 Entry ramp region

31 Entry ramp

32 Exit ramp

40 Entering vehicle (vehicle ready to cut in)

41 Vehicle ready to exit (vehicle ready to cut in)

50 Infrastructure facility

60 External surroundings detection system, for example in the infrastructure facility 50

70 Evaluation unit

B Turn signal

dB Distance amount

dE Ingress distance

dF Group following distance

dIstj Actual distance in front of the i-th vehicle with j=i−1

dmin Minimum distance

dSollj Setpoint distance in front of the i-th vehicle with j=i−1

E Ingress conditions

H Cut-in indication

i, j, k Index

K Ingress criterion

L Vehicle length

LMax Maximum length

LH Headlamp flasher

M Number of partial vehicle groups 1.k

N Number of vehicles 2i

NMax Maximum number of vehicles 2i in a partial vehicle group

R Intermediate space

T Trajectory

U Surroundings

UD Surroundings data

v1 Group speed

X.k Guide vehicle of the k-th partial vehicle group

Z Lead vehicle

St1, St1a, St1b, St1c, St1d, StT, St2, St3, St3 Steps of the method

What claimed is:

1. A method for coordinating a vehicle group comprising a number of vehicles, the vehicles of the vehicle group moving with specified setpoint distances to one another on a traffic lane and communicating wirelessly with one another via V2X communication, the specified setpoint distance being set by the respective vehicle by an adaptive cruise control system, comprising:
specifying the setpoint distances such that the vehicle group is permanently divided into a defined number of at least two partial vehicle groups and a guide partial vehicle group is followed by at least one following partial vehicle group, at least each following partial vehicle group being assigned its own guide vehicle, the guide vehicle of the respective following partial vehicle group leading the respective following partial vehicle group as the first vehicle; and
specifying a setpoint distance for the guide vehicle of the respective following partial vehicle group, which setpoint distance corresponds at least to a predefined ingress distance,
wherein the ingress distance is defined such that, after setting the ingress distance as the setpoint distance to a directly preceding vehicle of the same vehicle group, an intermediate space forms between the respective partial vehicle groups such that a vehicle which is ready to cut in and which has a vehicle length not exceeding a predefined maximum length is movable onto the traffic lane of the vehicle group into the intermediate space between the at least two partial vehicle groups.

2. The method of claim 1, wherein the ingress distance is defined in a manner dependent on the maximum length and a minimum distance in front of and behind the vehicle which is ready to cut in, and
wherein the maximum length is between 5 m and 10 m and the minimum distance lies between 10 m and 25 m in each case in front of and behind the vehicle which is ready to cut in, such that the ingress distance is defined as being between 25 m and 60 m.

3. The method of claim 1, wherein the setpoint distance which is specified for the guide vehicle of the respective following partial vehicle group is defined under the condition that, after setting the setpoint distance, vehicles of different partial vehicle groups are configured to continue to indirectly or directly communicate wirelessly with one another via the V2X communication to coordinate the vehicle group as a whole.

4. The method of claim 1, wherein, for all other vehicles of the vehicle group that are not guide vehicles of a following partial vehicle group, a setpoint distance to a directly preceding vehicle of the same partial vehicle group is specified which corresponds to a group following distance, and
wherein the group following distance is smaller than the ingress distance.

5. The method of claim 4, wherein the group following distance is set in a manner dependent on driving dynamics characteristics of the vehicles of the vehicle group, and
wherein the group following distance is less than 25 meters.

6. The method of claim 5, wherein the driving dynamics characteristics of the vehicles of the vehicle group are transmitted via the V2X communication to define the group following distance in a coordinated manner.

7. The method of claim 1, wherein, in the division of the vehicle group into at least two partial vehicle groups by specification and setting of the ingress distance as the setpoint distance in the guide vehicle of the respective following partial vehicle group, no communication is performed via the V2X communication with a vehicle which is ready to cut in.

8. The method of claim 1, wherein defining the number of partial vehicle groups considers that each partial vehicle group comprises a maximum number of vehicles, and
wherein the maximum number is between three and eight.

9. The method of claim 1, wherein the setpoint distance which is specified for the guide vehicle of the respective following partial vehicle group and which corresponds at least to the ingress distance is defined additionally in a manner dependent on whether the intermediate space formed by the ingress distance between the respective vehicle groups allows cutting-in of a vehicle which has been identified as being ready to cut in and which has a vehicle length, and
wherein, if it is determined that cutting-in is not possible, the setpoint distance is increased proceeding from the ingress distance.

10. The method of claim 9, wherein, when defining the setpoint distance, the method comprising checking whether the vehicle length of the vehicle which has been identified as being ready to cut in exceeds the specified maximum length, and
wherein, when the maximum length is exceeded, the setpoint distance is increased by a distance amount proceeding from the ingress distance.

11. The method of claim 9, wherein the identification of whether a vehicle is ready to cut in and the ascertainment of the vehicle length of the vehicle which has been identified as being ready to cut in is performed in a manner dependent on surroundings data,
wherein the surroundings data are output by at least one surroundings detection system, and
wherein the respective surroundings detection system is configured to monitor surroundings around the vehicle group.

12. The method of claim 11, wherein the surroundings data are transmitted via the V2X communication between the vehicles of the vehicle group and/or between the vehicles and an infrastructure facility outside the vehicle group, which infrastructure facility has an external surroundings detection system.

13. The method of claim 11, wherein the surroundings data from different surroundings detection systems are merged.

14. The method of claim 9, wherein checking of whether the intermediate space formed by the ingress distance between the respective partial vehicle groups allows cutting-in of a vehicle which has been identified as being ready to cut in and which has the vehicle length is performed only if the vehicle group is approaching an entry ramp and/or an exit ramp, such that an increase of the setpoint distance proceeding from the ingress distance is performable only if the vehicle group is approaching an entry ramp and/or an exit ramp.

15. The method of claim 9, wherein, after a detection that the vehicle which is ready to cut in has moved away again from the intermediate space, the ingress distance is specified as the setpoint distance for the guide vehicle of the respective following partial vehicle group.

16. The method of claim 9, wherein the setpoint distance which is specified for the guide vehicle of the respective following partial vehicle group and which corresponds at least to the ingress distance is defined additionally in a manner dependent on whether two or more vehicles which are ready to cut in are identified.

17. The method of claim 1, wherein the vehicle which is ready to cut in is an entering vehicle, which intends to move from an entry ramp onto the traffic lane of the vehicle group, or is a vehicle which is ready to exit, which intends to move from an adjacent traffic lane via the traffic lane of the vehicle group onto an exit ramp.

18. An evaluation unit for carrying out the method of claim 1, the evaluation unit being configured to:
define the setpoint distances between vehicles of a vehicle group such that the vehicle group is permanently divided into a defined number of at least two partial vehicle groups, such that a guide partial vehicle group is followed by at least one following partial vehicle group;
assign at least each following partial vehicle group a guide vehicle, the guide vehicle of the respective following partial vehicle group leading the respective following partial vehicle group as the first vehicle; and
specify a setpoint distance for the guide vehicle of the respective following partial vehicle group, which setpoint distance corresponds at least to a predefined ingress distance,
wherein the ingress distance is defined such that, after setting of the ingress distance as the setpoint distance to a directly preceding vehicle of the same vehicle group, an intermediate space forms between the respective partial vehicle groups such that a vehicle which is ready to cut in and which has a vehicle length not exceeding a predefined maximum length is movable onto the traffic lane of the vehicle group into the intermediate space between the at least two partial vehicle groups.

19. A lead vehicle of a vehicle group, comprising:
the evaluation unit of claim 18.

20. A vehicle group, comprising:
a plurality of vehicles,
wherein at least one of the vehicles of the plurality of vehicles, as lead vehicle, comprises the evaluation unit of claim 18,
wherein the lead vehicle is configured to communicate wirelessly with the plurality of vehicles of the vehicle group via V2X communication, and
wherein the each of the plurality of vehicles has an adaptive cruise control system,
wherein the adaptive cruise control system is in each case configured to set the setpoint distance, which is specified by the lead vehicle by the evaluation unit and which is transmitted via the V2X communication, to permanently divide the vehicle group into at least two partial vehicle groups.
